(19) United States
(12) Patent Application Publication
(10) Pub. No.: US 2021/0315159 A1
(43) Pub. Date: Oct. 14, 2021

(54) INFORMATION PROCESSING SYSTEM, INFORMATION PROCESSING DEVICE, AND NON-TRANSITORY STORAGE MEDIUM

(71) Applicant: TOYOTA JIDOSHA KABUSHIKI KAISHA, Toyota-shi (JP)

(72) Inventors: Wataru KYOCHIKA, Toyota-shi (JP); Riho MATSUO, Nagoya-shi (JP); Kenta MIYAHARA, Toyota-shi (JP); Ryotaro KAKIHARA, Nagoya-shi (JP)

(73) Assignee: TOYOTA JIDOSHA KABUSHIKI KAISHA, Toyota-shi (JP)

(21) Appl. No.: 17/226,837

(22) Filed: Apr. 9, 2021

(30) Foreign Application Priority Data
Apr. 14, 2020 (JP) 2020-072320

(51) Int. Cl. A01D 41/127; H04W 4/44; G06K 9/00; H04L 29/08; G08C 17/02; G05D 1/00; G05D 1/10; G05D 1/02

(52) U.S. Cl. CPC A01D 41/127; H04W 4/44; G06K 9/00657; H04L 67/12; G08C 17/02; G06Q 50/02; G05D 1/101; G05D 1/0287; G08C 2201/30; G05D 2201/0201; G05D 1/0016

(57) ABSTRACT

An information processing system includes a sensor, a server device, a user terminal, and a work device. The sensor detects a state of a crop. The server device includes a controller comprising at least one processor acquiring state information on the state of the crop based on an output of the sensor, generating first information based on the state information, and transmitting a work command to the work device. The user terminal notifies a user of the first information received from the server device and transmits, to the server device, second information that is input by the user and related to a work area. The controller of the server device transmits the work command to the work device, according to the second information.

### CROSS REFERENCE TO THE RELATED APPLICATION

This application claims the benefit of Japanese Patent Application No. 2020-072320, filed on Apr. 14, 2020, which is hereby incorporated by reference herein in its entirety.

### BACKGROUND

### Technical Field

This disclosure relates to an information processing system, an information processing device, and a non-transitory storage medium.

### Description of the Related Art

Patent Literature 1 discloses a technique related to a system for carrying out autonomous agriculture using a mobile robot. In this technique, a stationary robot system generates a set of instructions for transporting agricultural pods based on sensor data collected from a sensor module for monitoring crops. The mobile robot then transports the agricultural pods according to this set of instructions. Patent Literature 2 discloses a technique in which a farm is subdivided into a grid of assumed lines, location addresses are assigned according to the assumed lines, and communication devices for cultivation management installed at each location address are remotely controlled and managed.

Patent Literature 1: Japanese Patent Laid-Open No. 2019-068800

Patent Literature 2: Japanese Patent Laid-Open No. 2017-023021

### SUMMARY

An object of this disclosure is to improve the user convenience of agricultural work performed by users who produce crops.

The information processing system of this disclosure is an information processing system including: a sensor; a server device; a user terminal; and a work device, wherein the sensor detects a state of a crop cultivated in each section of a farm, the server device includes: a controller comprising at least one processor configured to perform acquiring state information on the state of the crop based on an output of the sensor, generating first information that is generated based on the state information and is to be transmitted to the user terminal, and transmitting a work command for causing the work device to perform predetermined work in the farm, the user terminal notifies a user of the first information received from the server device and transmits, to the server device, second information that is input by the user notified of the first information and related to a work area that is an area where the work device is to be caused to perform the predetermined work in the farm, and the controller of the server device transmits the work command to the work device, according to the second information transmitted from the user terminal.

In addition, this disclosure can be defined from an aspect of an information processing device. In particular, an information processing device of this disclosure includes a controller comprising at least one processor configured to perform: acquiring, based on an output of a sensor capable of detecting a state of a crop cultivated in each section of a farm, state information on the state of the crop; generating first information to transmit to a user terminal, the first information being information generated based on the state information; transmitting the first information to the user terminal; acquiring second information that is input to the user terminal by a user notified of the first information through the user terminal and related to a work area that is an area where a work device is to be caused to perform predetermined work in the farm; and transmitting a work command for causing the work device to perform predetermined work in the farm, according to the second information.

In addition, this disclosure can be defined from an aspect of a non-transitory storage medium. In particular, a non-transitory storage medium of this disclosure stores a program that causes a computer to execute an information processing method, the computer controlling a user terminal communicating with a server device that transmits a work command for causing a work device to perform predetermined work in a farm to the work device, wherein the information processing method includes: receiving, from the server device, first information generated based on state information on a state of a crop cultivated in each section of the farm; notifying a user of the first information; acquiring second information that is input by the user notified of the first information and related to a work area that is an area where the work device is to be caused to perform predetermined work in the farm; and transmitting the second information to the server device.

According to this disclosure, the user convenience of agricultural work performed by users who produce crops can be improved.

### BRIEF DESCRIPTION OF THE DRAWINGS

FIG. 1 is a diagram illustrating a schematic configuration of an information processing system according to a first embodiment;

FIG. 2 is a diagram illustrating the components of the information processing system according to the first embodiment in more detail;

FIG. 3 is a diagram for explaining first information generated by a generation unit in a control unit in a server;

FIG. 4 is a first diagram for explaining second information acquired by a second acquisition unit included in a control unit in the server;

FIG. 5 is a second diagram for explaining the second information acquired by the second acquisition unit included in the control unit in the server;

FIG. 6 is a third diagram for explaining the second information acquired by the second acquisition unit included in the control unit in the server;

FIG. 7 is a diagram illustrating a flow of the operation of an information processing system according to the first embodiment;

FIG. 8 is a diagram illustrating a notification screen related to the first information directed at the production user in the first embodiment;

FIG. 9 is a diagram illustrating a processing screen related to the acquisition of the second information;

FIG. 10 is a diagram illustrating the components of the information processing system according to a second embodiment in more detail;

FIG. 11 is a first diagram illustrating a notification screen related to the first information directed at the production user in the second embodiment;

FIG. 12 is a second diagram illustrating a notification screen related to the first information directed at the production user in the second embodiment;

FIG. 13 is a diagram illustrating a schematic configuration of an information processing system according to a third embodiment; and

FIG. 14 is a diagram illustrating the components of the information processing system according to a third embodiment in more detail.

### DESCRIPTION OF THE EMBODIMENTS

In the information processing system of this disclosure, a sensor detects the state of a crop cultivated in each section of the farm. Here, the state of the crop may be a state that should be recognized by the user in order to determine whether or not to perform predetermined work on the crop. The state of the crop is, for example, the appearance of the crop such as the size and color of the crop, and the water, fertilizer, and chemicals, and the like sprayed on the crop. The controller comprising at least one processor of the server device then acquires the state information on the state of the crop based on the output from the sensor. For instance, when the appearance of the crop is captured as an image by the sensor, the controller acquires the image information of the crop based on the output from the sensor. The controller then generates the first information to be transmitted to a user terminal. Here, the first information is information generated based on the acquired state information, and is generated by, for example, combining the state information with predetermined information. The controller then transmits the generated first information to the user terminal.

The user terminal notifies the user of the first information received from the server device. Here, if the controller of the server device generates the first information including the image information, the user terminal may notify the user of the first information by, for example, causing the input/output unit of the user terminal to display the first information including the image information. If the user terminal notifies the user of the first information, the user is prompted to input the second information to the user terminal. The user terminal then transmits the second information input by the user to whom the first information has been notified, to the server device. Note that the second information is information on a work area that is an area of the farm where the work device is allowed to perform predetermined work. Here, examples of the predetermined work include harvesting a crop in the farm, and spraying water, fertilizer, chemicals, and the like on the crop. As described above, in the information processing system of this disclosure, the work area is determined by the user. The controller of the server device that has acquired the second information on such a work area transmits a work command to perform predetermined work in the farm to the work device according to the second information. Consequently, the work device that has received this work command performs predetermined work in the work area determined by the user.

According to the information processing system described above, the user himself/herself determines the work area where the work device is to be caused to perform predetermined work in the farm according to the first information including the state information on the crop acquired based on the output from the sensor, and can remotely control the work device via the server device. This improves the user convenience of the agricultural work performed by the crop producing user.

Embodiments of this disclosure will now be described with reference to the accompanying drawings. The configurations in the embodiments below are merely illustrative, and this disclosure is not limited to the configurations in the embodiments.

### First Embodiment

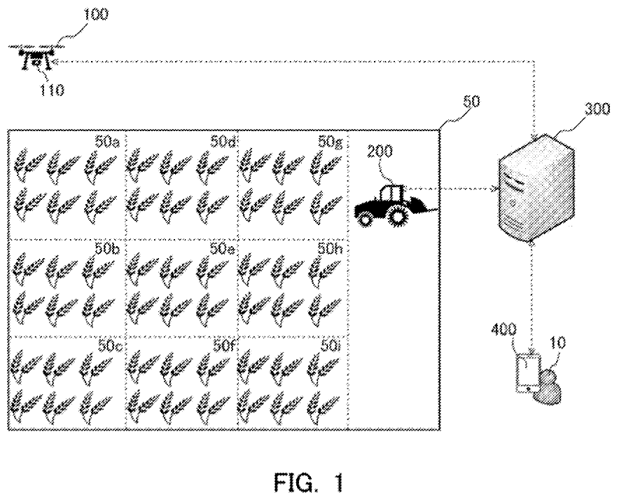

The outline of an information processing system according to the first embodiment will be described with reference to FIG. 1. The information processing system according to this embodiment includes an unmanned aircraft 100 equipped with a sensor that senses the state of the crop cultivated in each section of the farm 50 (which may hereinafter be simply referred to as “crop”), an unmanned tractor 200 for harvesting crops, a server 300, and a user terminal 400 owned by a crop production user 10. Here, the unmanned aircraft 100 in this embodiment is, but not intentionally limited to, a multicopter equipped with a plurality of rotors, a so-called drone, and can be of any type as long as it can move over the farm 50. Aside from that, the unmanned tractor 200 in this embodiment may be of any type as long as it can harvest crops.

The unmanned aircraft 100 has a camera 110, as the aforementioned sensor, that can capture images of the crop cultivated in each section of the farm 50. The camera 110 is, for example, a charged-coupled device (CCD) or imaging device using metal-oxide-semiconductor (MOS) or complementary metal-oxide-semiconductor (CMOS) image sensors, and can detect the state of a crop by capturing images of the crop. In this case, the camera 110 provided in the unmanned aircraft 100 corresponds to the sensor according to this disclosure. The unmanned aircraft 100 may be provided with a single camera 110 or a plurality of cameras 110 as a mobile imaging device that can capture images of crops.

The server 300 is configured to be able to communicate with the unmanned aircraft 100, and acquires outputs from the camera 110 provided in the unmanned aircraft 100 by communicating with the unmanned aircraft 100, thereby acquiring image information on a state of a crop (still image information or video information). In other words, the server 300 acquires image information which is state information on the state of the crop based on the output from the camera 110. The server 300 then generates the first information including the acquired crop image information. Here, the server 300 is configured to be able to communicate with the user terminal 400, and transmits the generated first information to the user terminal 400, and the user terminal 400 receiving this information notifies the production user 10 of the first information. Hence, the production user 10 notified of the first information can determine the area of the farm 50 where the crop is to be harvested, referring to the first information. To be specific, the production user 10 can input, to the user terminal 400, the second information on the work area that is the area of the farm 50 where the unmanned tractor 200 is caused to harvest the crop. Here, in this embodiment, the farm 50 has a plurality of plots (plots 50a to 50i). In this case, determining that predetermined plots (for example, a plot 50a, 50d, and 50g) of the plurality of plots (plots 50a to 50i) are the aforementioned work area, the production user 10 can input the second information on the work area. The user terminal 400 to which the second information has been input by the production user 10 then transmits the second information to the server 300.

The server 300 is configured to be able to communicate with the unmanned tractor 200. The server 300 then transmits a work command for harvesting crops in the farm 50 to the unmanned tractor 200 based on the second information transmitted from the user terminal 400. Then, the unmanned tractor 200 that has received the work command harvests the crops within the work area defined by the production user 10. In other words, the production user 10 determines the work area where the unmanned tractor 200 is caused to harvest the crop, based on the monitoring information on the farm 50 acquired using the camera 110 of the unmanned aircraft 100 and remotely controls the unmanned tractor 200 via the server 300.

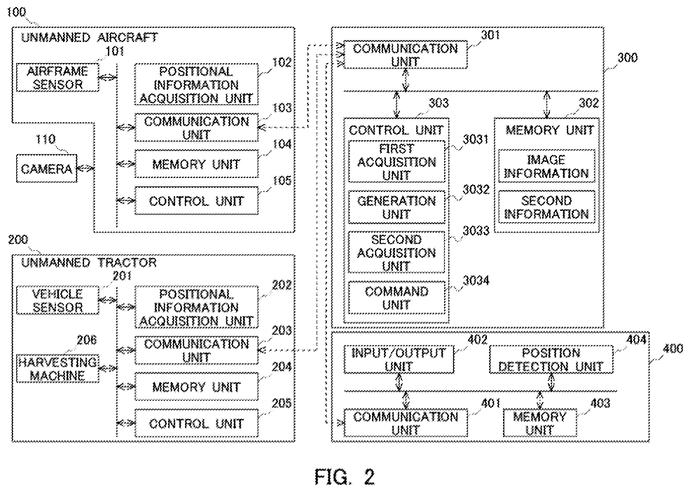

Next, the detailed description of the components of the server 300 will be mainly given referring to FIG. 2. FIG. 2 illustrates in more detail the components of the server 300 included in the information processing system according to the first embodiment, and illustrates the components of the unmanned aircraft 100, the unmanned tractor 200, and the user terminal 400 that communicate with the server 300.

The server 300 may be made up of a general-purpose computer. In other words, the server 300 can be made up of a computer including a processor such as a CPU or GPU, a main memory such as a RAM or ROM, and an auxiliary memory such as an EPROM, a hard disk drive, or a removable medium. Note that the removable medium may be, for example, a USB memory or a disk recording medium such as a CD or DVD. The auxiliary memory stores an operating system (OS), various programs, various tables, and the like. The server 300 includes a communication unit 301, a memory unit 302, and a control unit 303 as functional units, and loads the programs stored in the auxiliary memory to a work area in the main memory and executes it, and through the execution of the programs, each functional unit or the like is controlled, so that each function meeting a predetermined purpose in each functional unit can be implemented. Note that some or all of the functions may be implemented using a hardware circuit such as an ASIC or FPGA.

Here, the communication unit 301 is a communication interface for connecting the server 300 to a network. The communication unit 301 includes, for example, a network interface board and a wireless communication circuit for wireless communication. The server 300 is communicably connected to the unmanned aircraft 100, the unmanned tractor 200, the user terminal 400, and other external devices via the communication unit 301.

The memory unit 302 includes a main memory and an auxiliary memory. The main memory is a memory in which a program to be executed by the control unit 303 or data to be used for the program is expanded. The auxiliary memory stores a program to be executed by the control unit 303 or data to be used for the control program. The memory unit 302 stores data transmitted from the unmanned aircraft 100, the user terminal 400, and the like. The server 300 acquires these data via the communication unit 301. The memory unit 302 then stores crop image information acquired based on the output from the camera 110 and the second information transmitted from the user terminal 400, for example.

The control unit 303 is a functional unit that controls the control performed by the server 300. The control unit 303 can be implemented using an arithmetic processing unit such as a CPU. The control unit 303 further includes four functional units: a first acquisition unit 3031, a generation unit 3032, a second acquisition unit 3033, and a command unit 3034. Each functional unit may be implemented by executing the stored program in the CPU.

The first acquisition unit 3031 acquires an output from camera 110 that has detected the state of the crop by capturing images of the crop by communicating with the unmanned aircraft 100, thereby acquiring image information (still image information or video information) that is the state information on the state of the crop. This image information includes information on the appearance of the crop, such as the size and color of the crop. The first acquisition unit 3031 then stores the acquired image information in the memory unit 302 of the server 300.

Here, the unmanned aircraft 100 in this embodiment is an autonomous flying mobile body that autonomously moves according to commands from an external device. In this case, the unmanned aircraft 100 includes an airframe sensor 101, a positional information acquisition unit 102, a communication unit 103, a memory unit 104, and a control unit 105. The airframe sensor 101 is a means for sensing the state of the airframe and the periphery of the airframe. Examples of the airframe sensor 101 for sensing the state of the airframe include an acceleration sensor, a speed sensor, and an azimuth sensor. Examples of the airframe sensor 101 for sensing the periphery of the airframe include a stereo camera for flight, a laser scanner, LIDAR, and a radar. The information acquired by the airframe sensor 101 is transmitted to the control unit 105. The positional information acquisition unit 102 is a means for acquiring the current position of the unmanned aircraft 100, and is typically a global positioning system (GPS) device that receives GPS satellite signals to obtain positional information. The positional information obtained from the GPS device represents latitude, longitude, and altitude. The positional information acquisition unit 102 may be a positioning device by any global navigation satellite system (GNSS) other than GPS as long as it can acquire the current position of the unmanned aircraft 100 and may be a positioning device based on base station positioning. The communication unit 103 is a communication interface for connecting the unmanned aircraft 100 to the network, and includes, for example, a network interface board and a wireless communication circuit for wireless communication. The memory unit 104 includes a main memory and an auxiliary memory like the memory unit 302 of the server 300, and the airframe information on the unmanned aircraft 100 is registered in the memory unit 104. Note that such registration of airframe information is performed in advance through a predetermined application. The control unit 105 is a computer that controls the autonomous movement of the unmanned aircraft 100. The control unit 105 consists of, for example, a microprocessor and a memory storing a program, and functions when the microprocessor executes the program. Note that a part or all of the functions may be implemented by a logic circuit such as an application specific integrated circuit (ASIC) or a field programmable gate array (FPGA).

Subsequently, in such an unmanned aircraft 100, the control unit 105 controls the flight of the unmanned aircraft 100 according to an operation schedule from an external device, the state of the airframe and the situation around the airframe acquired by the airframe sensor 101, and the positional information on the airframe acquired by the positional information acquisition unit 102. The operation schedule is data that defines the route of the unmanned aircraft 100 and the processing that the unmanned aircraft 100 should perform in a part of the route. In this embodiment, the route of the unmanned aircraft 100 includes a route over the farm 50, and the camera 110 is controlled so that images of the crops cultivated in each section in the farm 50 can be captured over the farm 50. However, the unmanned aircraft 100 is not intentionally limited to such an autonomous mobile body, and the unmanned aircraft 100 may be operated by a predetermined user.

The generation unit 3032 generates the first information including crop image information from the image information acquired by the first acquisition unit 3031 and stored in the memory unit 302. The generation unit 3032 then transmits the generated first information to the user terminal 400. Then, the user terminal 400 notifies the production user 10 of the first information.

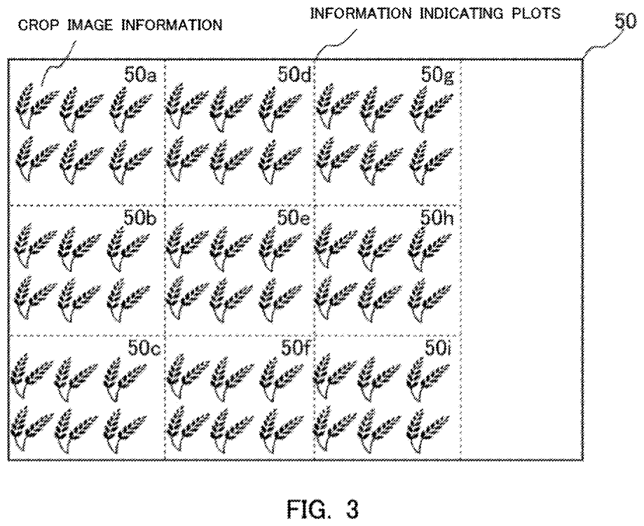

FIG. 3 is a diagram for explaining the first information generated by the generation unit 3032. In this embodiment, as illustrated in FIG. 3, the first information is generated by superimposing the information indicating a plot of the farm 50 on the crop image information. Note that image information indicating each section of the farm 50 and information indicating the plot corresponding to each section of the farm 50 are associated with each other and prestored in the memory unit 302 of the server 300. Hence, the generation unit 3032 can generate the first information by superimposing the information indicating the plot of the farm 50 on the crop image information. When the camera 110 of the unmanned aircraft 100 detects the state of the crop for each plot of the farm 50, the image information acquired based on the output from the camera 110 includes crop image information for each plot of the farm 50. In this case, the generation unit 3032 can generate the first information by superimposing the information indicating the plot on the crop image information for each plot of the farm 50.

As illustrated in FIG. 2, the user terminal 400 in this embodiment has a communication unit 401, an input/output unit 402, a memory unit 403, and a position detection unit 404 as functional units. The communication unit 401 is a communication interface for connecting the user terminal 400 to the network, and includes, for example, a network interface board and a wireless communication circuit for wireless communication. The input/output unit 402, which is a functional unit for displaying information and the like transmitted from external devices via the communication unit 401, and inputting the information upon transmission of the information to an external device via the communication unit 401, includes a display device and a touchscreen, for example. The memory unit 403 includes a main memory and an auxiliary memory like the memory unit 302 of the server 300, and the user information on the production user 10 who owns the user terminal 400 is stored in the memory unit 403. Note that this user information is pre-registered through a predetermined application. The position detection unit 404 is a functional unit for detecting the position of the user terminal 400, and includes, for example, a GPS device.

Returning to FIG. 2, the second acquisition unit 3033 acquires the second information on a work area of the farm 50 where the unmanned tractor 200 is to be caused to harvest the crop (which may hereinafter be simply referred to as “work area”) input to the user terminal 400 by the production user 10. The second acquisition unit 3033 acquires the second information by receiving the second information transmitted from the user terminal 400 via the communication unit 301. The second acquisition unit 3033 then stores the acquired second information in the memory unit 302 of the server 300.

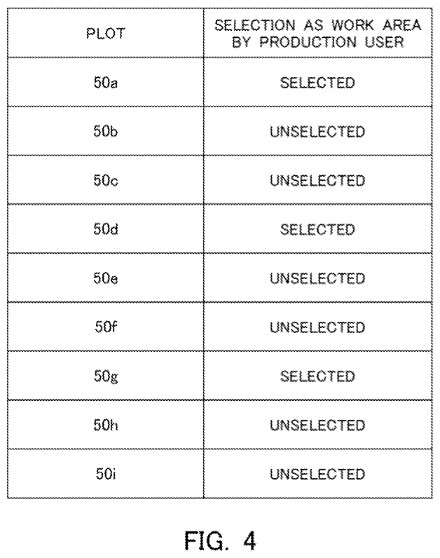

FIG. 4 is a first diagram for explaining the second information acquired by the second acquisition unit 3033. The production user 10 notified of the first information can input the second information on a work area, using a predetermined plot of the plurality of plots (plots 50a to 50i) illustrated in FIG. 3 as the work area. Referring to FIG. 4, plots 50a, 50d, and 50g as work areas are being selected by the production user 10. In this case, the information illustrated in FIG. 4, that is, the information including selection or unselection as a work area by the production user 10 for each plot of the farm 50 serves as the second information.

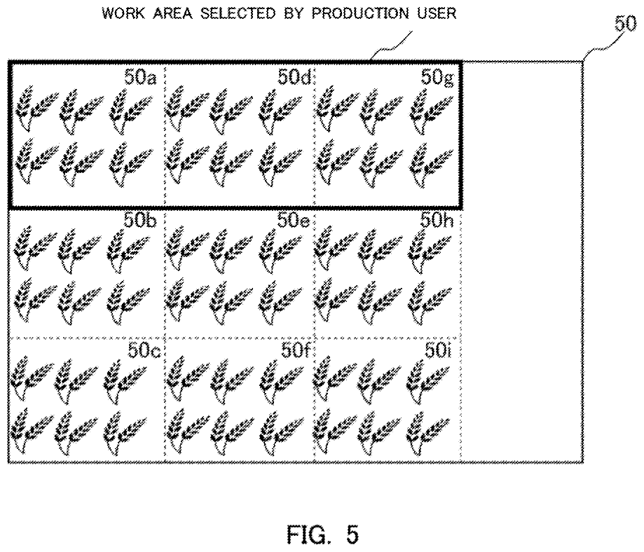

FIG. 5 is a second diagram for explaining the second information acquired by the second acquisition unit 3033. Referring to FIG. 5, in the crop image information on which the information indicating a plot of the farm 50 is superimposed, the plots 50a, 50d, and 50g as work areas are being selected by the production user 10. In this way, the second information may be obtained by adding information indicating the plot selected as a work area by the production user 10 to the crop image information.

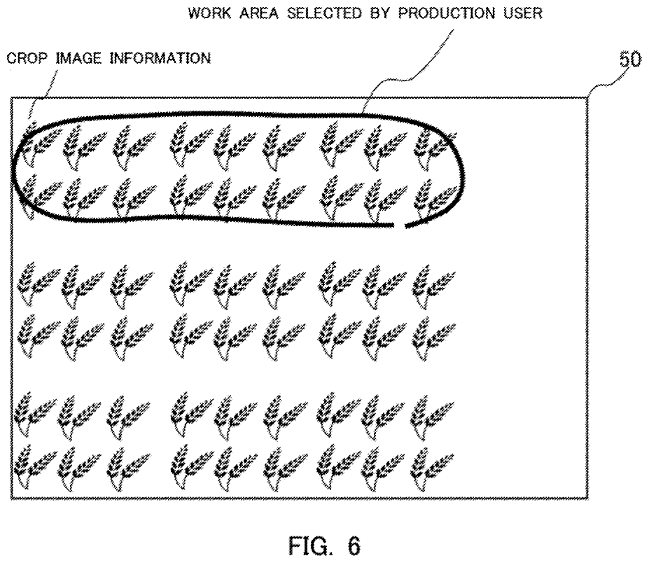

Although the farm 50 with a plurality of predetermined plots is described as an example in this embodiment, the plots are not necessarily be defined in the farm 50. In this case, the production user 10 may select an arbitrary area as a work area from the crop image information. FIG. 6 is a third diagram for explaining the second information acquired by the second acquisition unit 3033. FIG. 6 illustrates that, in the crop image information, an arbitrary section of the farm 50 is being selected by the production user 10. In this way, the second information may be obtained by adding information indicating an arbitrary section of the farm 50 selected as a work area by the production user 10 to the crop image information.

Returning to FIG. 2, the command unit 3034 transmits a work command for harvesting the crop in the farm 50 to the unmanned tractor 200, according to the second information acquired by the second acquisition unit 3033 and stored in the memory unit 302. Accordingly, the unmanned tractor 200 that has received this work command harvests the crop in the work area defined by the production user 10. In this case, the unmanned tractor 200 corresponds to the work device according to this disclosure. The unmanned tractor that harvests the crop in the farm 50 may be one unmanned tractor 200 or a plurality of unmanned tractors 200.

Here, the unmanned tractor 200 in this embodiment is an autonomous mobile body that autonomously moves according to commands from an external device. In this case, the unmanned tractor 200 includes a vehicle sensor 201, a positional information acquisition unit 202, a communication unit 203, a memory unit 204, and a control unit 205. The vehicle sensor 201 is a means for sensing the state of the vehicle and the periphery of the vehicle. Examples of the vehicle sensor 201 for sensing the state of the vehicle include an acceleration sensor, a speed sensor, and an azimuth sensor. Examples of the vehicle sensor 201 for sensing the periphery of the vehicle include a stereo camera for driving, a laser scanner, LIDAR, and a radar. The information acquired by the vehicle sensor 201 is transmitted to the control unit 205. The positional information acquisition unit 202 is a means for acquiring the current position of the unmanned tractor 200, and is typically a global positioning system (GPS) device that receives GPS satellite signals to obtain positional information. The positional information obtained from the GPS device represents latitude, longitude, and altitude. The positional information acquisition unit 202 may be a positioning device by any global navigation satellite system (GNSS) other than GPS as long as it can acquire the current position of the unmanned tractor 200 and may be a positioning device based on base station positioning. The communication unit 203 is a communication interface for connecting the unmanned tractor 200 to the network, and includes, for example, a network interface board and a wireless communication circuit for wireless communication. The memory unit 204 includes a main memory and an auxiliary memory like the memory unit 302 of the server 300, and the vehicle information on the unmanned tractor 200 is registered in the memory unit 204. Note that such registration of vehicle information is performed in advance through a predetermined application. The control unit 205 is a computer that controls the autonomous movement of the unmanned tractor 200. The control unit 205 consists of, for example, a microprocessor and a memory storing a program, and functions when the microprocessor executes the program. Note that a part or all of the functions may be implemented by a logic circuit such as an application specific integrated circuit (ASIC) or a field programmable gate array (FPGA).

Subsequently, in such an unmanned tractor 200, the control unit 205 controls the driving of the unmanned tractor 200 according to an operation schedule from an external device, the state of the vehicle and the situation around the vehicle acquired by the vehicle sensor 201, and the positional information on the vehicle acquired by the positional information acquisition unit 202. The operation schedule is data that defines the route of the unmanned tractor 200 and the processing that the unmanned tractor 200 should perform in a part of the route. Here, in this embodiment, the aforementioned work command transmitted from the server 300 includes an operation schedule for the unmanned tractor 200. To be specific, the route of the travel of the unmanned tractor 200 for the operation schedule is defined so that the unmanned tractor 200 can harvest the crop in the aforementioned work area of the farm 50. Subsequently, for the operation schedule, processing of activating the harvesting machine 206 provided in the unmanned tractor 200 in the work area that is a part of the aforementioned travel route is defined.

Note that the control unit 303 functions as a control unit according to this disclosure, executing processing in the first acquisition unit 3031, the generation unit 3032, the second acquisition unit 3033, and the command unit 3034.

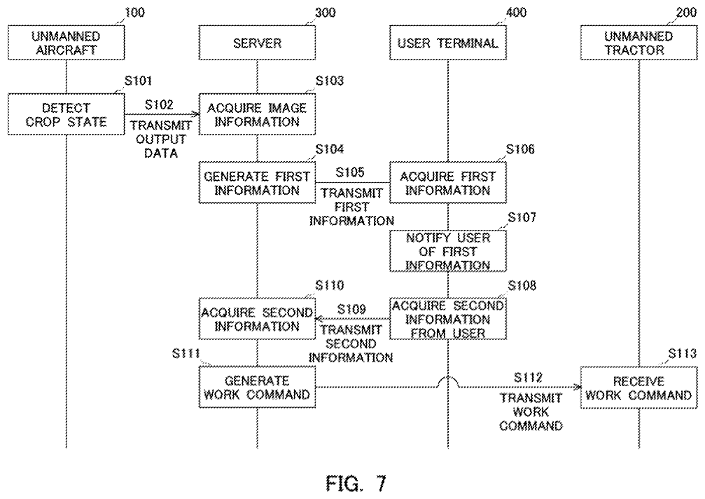

The flow of the operation of the information processing system according to this embodiment will now be explained. FIG. 7 is a diagram illustrating the flow of the operation of the information processing system according to this embodiment. The flow of the operation between the components of the information processing system and the processing executed by each component will be explained with reference to FIG. 7.

In this embodiment, first, the state of the crop cultivated in each section of the farm 50 is detected by the unmanned aircraft 100, and the related output data is transmitted to the server 300. The unmanned aircraft 100 detects the state of the crop by capturing images of the crop using the camera 110 provided in the unmanned aircraft 100 (S101). In other words, the camera 110 corresponding to the sensor according to this disclosure detects the state of the crop. The unmanned aircraft 100 transmits the output data from the camera 110 to the server 300 (S102).

Next, the server 300 generates the first information based on the image information of the crop. The server 300 receives the aforementioned output data transmitted from the unmanned aircraft 100 via the communication unit 301 to acquire the image information (still image information or video information) that is state information on the state of the crop (S103). The server 300 then generates the first information including the image information, based on the acquired image information (S104). Note that, for example, as illustrated in FIG. 3 described above, the server 300 can generate the first information by superimposing the information indicating the plot of the farm 50 on the crop image information. The server 300 then transmits the generated first information to the user terminal 400 (S105).

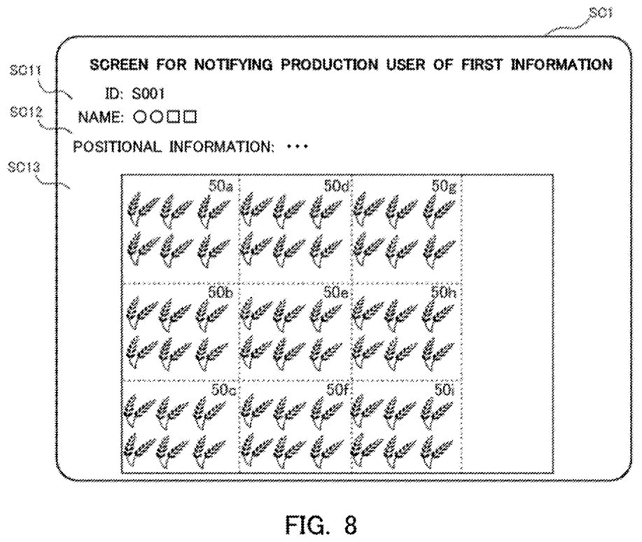

Next, the user terminal 400 notifies the production user 10 of the first information, and the production user 10 inputs the second information to the user terminal 400. The user terminal 400 acquires the first information by receiving the first information transmitted from the server 300 via the communication unit 401 (S106). The user terminal 400 then notifies the production user 10 of the acquired first information (S107). This will be described with reference to FIG. 8. FIG. 8 is a diagram illustrating a notification screen related to the first information directed at the production user 10 in the first embodiment. The notification screen SC1 illustrated in FIG. 8 is a screen for notifying the production user 10 of the first information, and is displayed on the input/output unit 402 of the user terminal 400 owned by the production user 10. The notification screen SC1 shows user information SC11 (ID and name), positional information SC12, and first information SC13. The user information SC11 represents the user information on the production user 10 stored in the memory unit 403 of the user terminal 400. The positional information SC12 represents the positional information on the farm 50. The first information SC13 represents the first information transmitted from the server 300. The user terminal 400 notifies the production user 10 of the acquired first information by displaying such a notification screen on the input/output unit 402.

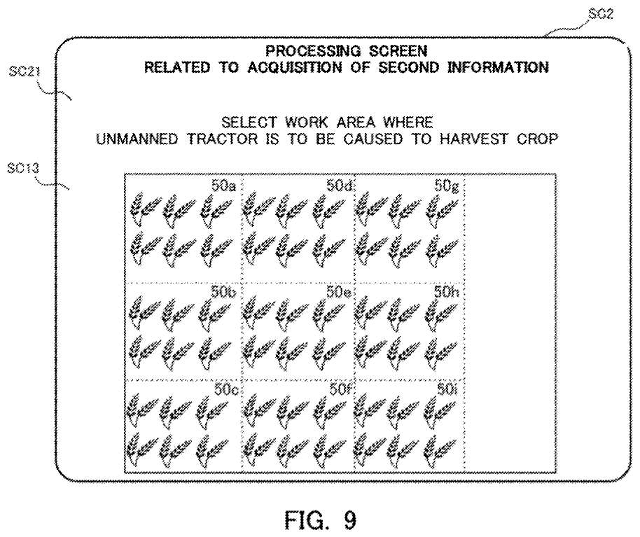

Subsequently, returning to FIG. 7, the user terminal 400 acquires the second information, input by the production user 10 notified of the first information, on the work area of the farm 50 in which the unmanned tractor 200 is to be caused to harvest the crop (S108). This will be described with reference to FIG. 9. FIG. 9 is a diagram illustrating a processing screen related to acquisition of the second information. The processing screen SC2 illustrated in FIG. 9 is a screen for acquiring the second information from the production user 10, and is displayed on the input/output unit 402 of the user terminal 400 owned by the production user 10. The processing screen SC2 shows the message information SC21 for the production user 10 and the first information SC13. Consequently, as described above, the production user 10 can select a predetermined plot as a work area from the crop image information (first information SC13) on which the information indicating the plot of the farm 50 is superimposed. Subsequently, returning to FIG. 7, the user terminal 400 transmits the second information on the work area input by the production user 10 to the server 300 (S109).

Next, the server 300 generates a work command based on the second information, and the work command is transmitted to the unmanned tractor 200. The server 300 acquires the second information by receiving the second information transmitted from the user terminal 400 via the communication unit 301 (S110). The server 300 then generates a work command for causing the unmanned tractor 200 to harvest the crops in the farm 50, from the acquired second information (S111). As described above, the server 300 can generate the aforementioned work command including the operation schedule for the unmanned tractor 200. The server 300 then transmits the generated work command to the unmanned tractor 200 (S112).

Next, the unmanned tractor 200 receives the work command transmitted from the server 300 (S113). The unmanned tractor 200 that has received the work command then harvests the crop in the work area defined by the production user 10.

With the operation of the information processing system described above, the production user 10 can determine the work area where the unmanned tractor 200 is caused to harvest the crop, according to the crop image information acquired using the camera 110 of the unmanned aircraft 100, and can remotely control the unmanned tractor 200 via the server 300. This increases the user convenience in the farm work by the user producing the crop.

Regarding the state of the crop, the state of the crop may be detected by the camera 120 provided in the farm 50 instead of detection by the camera 110 provided on the unmanned aircraft 100. In this case, the camera 120 provided in the farm 50 corresponds to the sensor according to the present invention, and the farm 50 may be provided with one camera 120 or a plurality of cameras 120 as a stationary imaging device that can capture images of crops.

Further, the user terminal 400 may have the function of the server 300 described above. In this case, the unmanned aircraft 100 and the unmanned tractor 200 communicate with the user terminal 400.

### Second Embodiment

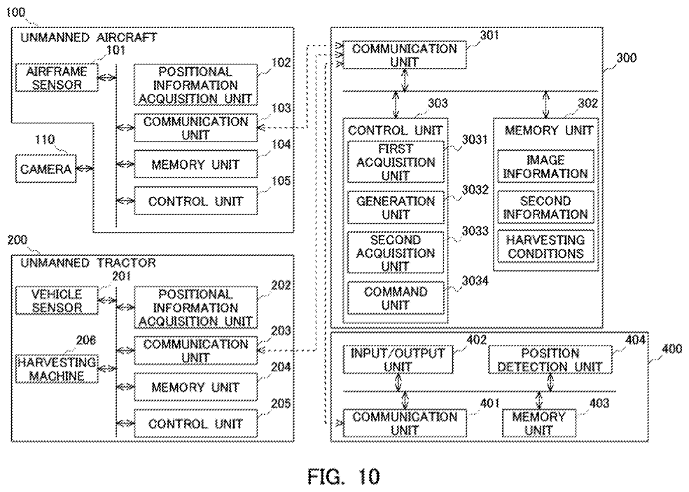

The second embodiment will be described with reference to FIGS. 10 to 12. FIG. 10 illustrates in more detail the components of the server 300 included in the information processing system according to the second embodiment, and also illustrates the components of the unmanned aircraft 100, the unmanned tractor 200, and the user terminal 400 that communicate with the server 300.

In this embodiment, the memory unit 302 of the server 300 stores crop harvesting conditions besides crop image information acquired based on the output from the camera 110 and the second information transmitted from the user terminal 400. This harvesting conditions are information used for determining the time to harvest the crop cultivated in each section of the farm 50, and are pre-registered by the production user 10. The generation unit 3032 included in the control unit 303 of the server 300 then generates proposal information on a proposal of a target area in the farm 50 where the unmanned tractor 200 is to be caused to harvest the crop, from the image information acquired by the first acquisition unit 3031 and stored in the memory unit 302 and the harvesting conditions stored in the memory unit 302, thereby generating information including crop image information and the proposal information as the first information. This will be described below.

As described above, the image information includes information on the appearance of the crop, such as the size and color of the crop. The production user 10 can determine the time to harvest the crop based on such image information. In this embodiment, the crop harvesting conditions determined according to the appearance of the crop are pre-registered in the memory unit 302 of the server 300 by the production user 10. To be specific, the production user 10 determines the crop harvesting conditions, for example, that the size of the crop is a predetermined size or more and the color of the crop is a predetermined color, and pre-registers them in the memory unit 302 of the server 300. Further, the production user 10 may determine the required yield of the crop per day and pre-register it in the memory unit 302 of the server 300 as the crop harvesting conditions.

Accordingly, the generation unit 3032 according to this embodiment checks the image information acquired by the first acquisition unit 3031 and stored in the memory unit 302 against the harvesting conditions stored in the memory unit 302 to specify the crop satisfying the harvesting conditions among the crops cultivated in each section of the farm 50. Determining that the section of the farm 50 containing the crop satisfying the harvesting conditions to be a target area where the unmanned tractor 200 is to be caused to harvest the crop, the generation unit 3032 then generates proposal information on a proposal of the target area. The generation unit 3032 then generates the first information including the crop image information and the proposal information generated in this way, and transmits the generated first information to the user terminal 400. Accordingly, the user terminal 400 notifies the production user 10 of the first information.

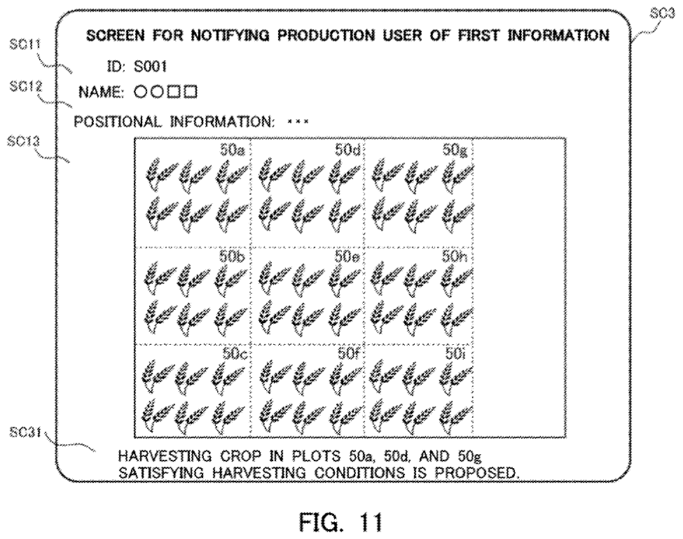

FIG. 11 is a first diagram illustrating a notification screen related to the first information directed at the production user 10 in the second embodiment. The notification screen SC3 illustrated in FIG. 11 is a screen for notifying the production user 10 of the first information including the aforementioned proposal information, and is displayed on the input/output unit 402 of the user terminal 400 owned by the production user 10. The notification screen SC3 shows user information SC11 (ID and name), positional information SC12, first information SC13, and proposal information SC31. Proposal information SC31 indicates message information on a proposal of a target area where the unmanned tractor 200 is to be caused to harvest the crop. The user terminal 400 notifies the production user 10 of the acquired first information by displaying such a notification screen on the input/output unit 402.

Subsequently, the user terminal 400 acquires the second information, input by the production user 10 notified of the first information, on the work area of the farm 50 in which the unmanned tractor 200 is to be caused to harvest the crop. At this time, for example, the production user 10 selects a predetermined plot as a work area from the crop image information on which the information indicating a plot of the farm 50 is superimposed on the processing screen related to the acquisition of the second information illustrated in FIG. 9 described above; thus, the second information is input.

Note that the generation unit 3032 in this embodiment may generate the aforementioned proposal information by learning the second information previously input by the production user 10. The production user 10 inputs the second information to the user terminal 400 by determining the time to harvest the crop based on crop image information. Therefore, it can be said that the crop included in the work area input as the second information by the production user 10 is ready for harvest. Hence, the generation unit 3032 can generate crop harvesting conditions by learning the appearance of the crop included in the work area previously input as the second information by the production user 10. In this case, the generation unit 3032 may generate proposal information based on the image information acquired by the first acquisition unit 3031 and stored in the memory unit 302, and the harvesting conditions generated by learning.

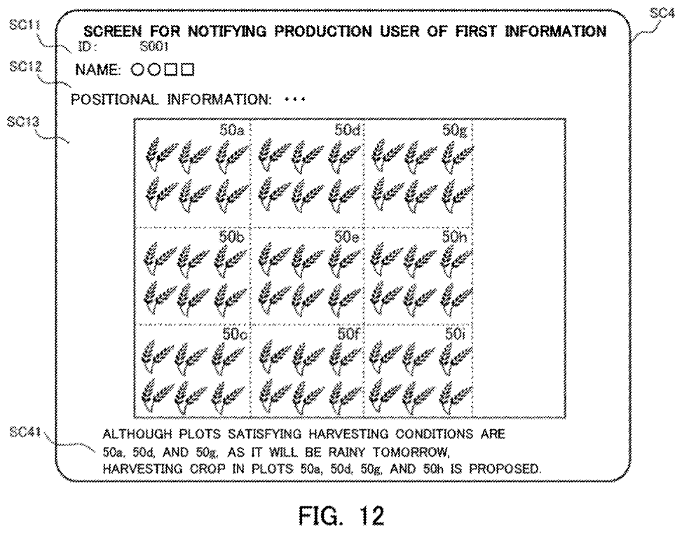

The generation unit 3032 in this embodiment may further acquire the third information on the weather forecast for the area including the farm 50, and generate proposal information from the image information acquired by the first acquisition unit 3031 and stored in the memory unit 302, the harvesting conditions stored in memory unit 302, and the third information. This will be described with reference to FIG. 12. FIG. 12 is a second diagram illustrating a notification screen related to the first information to the production user 10 in the second embodiment. The notification screen SC4 illustrated in FIG. 12 is a screen for notifying the production user 10 of the first information including the aforementioned proposal information, and is displayed on the input/output unit 402 of the user terminal 400 owned by the production user 10. The notification screen SC4 shows user information SC11 (ID and name), positional information SC12, first information SC13, and proposal information SC41. Proposal information SC41 indicates message information on a proposal of a target area where the unmanned tractor 200 is to be caused to harvest the crop. FIG. 12 illustrates an example in which the fact that the weather forecast for tomorrow for the area including the farm 50 is rain is acquired as the third information, and in this case, the generation unit 3032 determines that the weather for tomorrow is not suitable for harvesting crops, sets the target area where the unmanned tractor 200 is to be caused to harvest crops today wider than the section containing the crop satisfying the harvesting conditions, and generates proposal information on the proposal for the target area. When it is determined that the next-day weather is suitable for harvesting crops, the generation unit 3032 may set the target area where the unmanned tractor 200 is to be caused to harvest crops on the day narrower than the section containing the crop satisfying the harvesting conditions, and generate proposal information on the proposal for the target area.

With the information processing system described above, the production user 10 can determine the work area where the unmanned tractor 200 is caused to harvest the crop, according to the crop image information acquired using the camera 110 of the unmanned aircraft 100 and the proposal information generated by the server 300, and can remotely control the unmanned tractor 200 via the server 300. In this way, the user convenience in the farm work by the user producing the crop can be improved.

### Third Embodiment

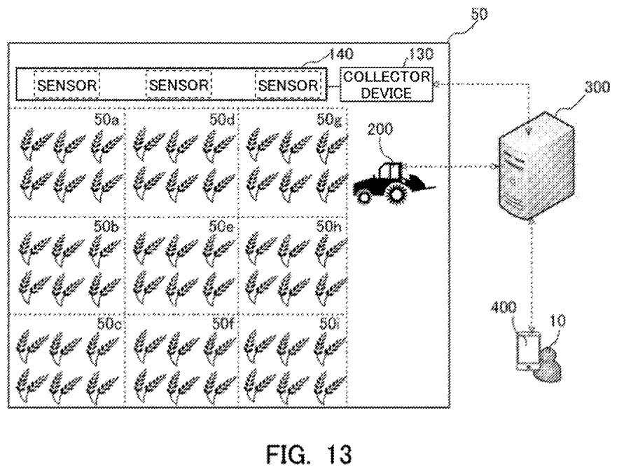

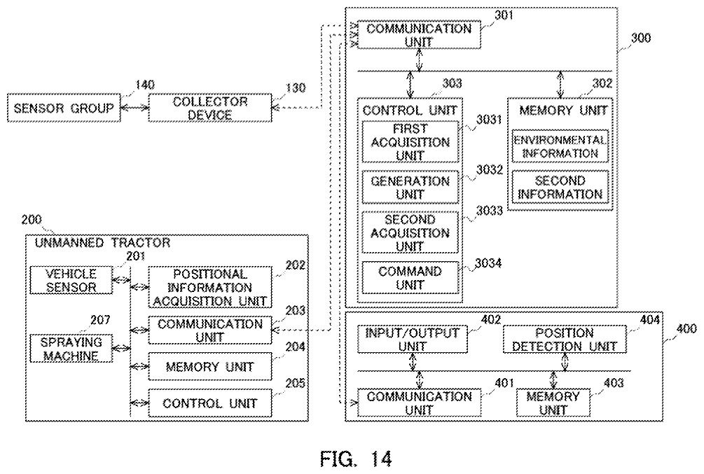

The third embodiment will be described with reference to FIGS. 13 and 14. FIG. 13 is a diagram illustrating a schematic configuration of an information processing system according to the third embodiment. FIG. 14 illustrates in more detail the components of the server 300 included in the information processing system according to the third embodiment, and also illustrates the components of a collector device 130, the unmanned tractor 200, and the user terminal 400 that communicate with the server 300.

In the first embodiment described above, an example has been illustrated in which the server 300 acquires image information on a crop as state information on the state of the crop in the farm 50, and transmits a work command for harvesting the crop to the unmanned tractor 200, according to the second information input by the production user 10. In contrast, in this embodiment, an example will be described in which the server 300 acquires environmental information on a crop indicating the state of spraying of water, fertilizer, chemicals, and the like as state information, and transmits a work command for spraying these on the crop to the unmanned tractor 200, according to the second information input by the production user 10.

Here, as illustrated in FIG. 13, the collector device 130 in this embodiment is a device that collects detection data from each sensor included in the sensor group 140 provided in the farm 50. Regarding the data collection from each sensor by the collector device 130, data temporarily stored in each sensor may be collected at a fixed cycle, or detection data transmitted from each sensor in the push manner may be collected each time.

The sensor group 140 in this embodiment includes an environment sensor that detects the state of spraying of water, fertilizer, chemicals, and the like on the crop. Note that the detection of the state of spraying of water, fertilizer, chemicals, and the like on crops by the environment sensor can be achieved by the existing technology. In addition, the environment sensor can be provided in an arbitrary position in the farm 50.

Further, as illustrated in FIG. 14, the server 300 is configured to be communicable with the collector device 130, and can acquire environmental information on the conditions of crops, by communicating with the collector device 130 to acquire the detection data given by the sensor group 140 collected by the collector device 130. In other words, the server 300 acquires environmental information on the states of the crops based on the output of the sensor group 140.

The first acquisition unit 3031 in the control unit 303 of the server 300 then acquires the output of the sensor group 140 that has detected the state of spraying of water, fertilizer, chemicals, and the like on crops by communicating with the collector device 130, thereby acquiring environmental information indicating the state of spraying of water, fertilizer, chemicals, and the like on crops, as crop state information. The first acquisition unit 3031 then stores the acquired environmental information in the memory unit 302 of the server 300.

The generation unit 3032 generates the first information including environmental information on the crops from the environmental information acquired by the first acquisition unit 3031 and stored in the memory unit 302. The generation unit 3032 then transmits the generated first information to the user terminal 400. Then, the user terminal 400 notifies the production user 10 of the first information. Here, the generation unit 3032 can generate the first information by superimposing the information indicating the plot of the farm 50 on the environmental information on the crop, for example.

The second acquisition unit 3033 acquires the second information, input to the user terminal 400 by the production user 10, on the work area of the farm 50 in which the unmanned tractor 200 is to be caused to spray water, fertilizer, chemicals, and the like on crops. The second acquisition unit 3033 then stores the acquired second information in the memory unit 302 of the server 300.

The command unit 3034 transmits a work command for spraying water, fertilizer, chemicals, and the like on crops in the farm 50 to the unmanned tractor 200, according to the second information acquired by the second acquisition unit 3033 and stored in the memory unit 302. Accordingly, the unmanned tractor 200 that has received this work command sprays water, fertilizer, chemicals, and the like on the crop in the work area defined by the production user 10. Note that the unmanned tractor 200 is an autonomous moving body that autonomously moves according to commands from an external device, and as described above, the control unit 205 of the unmanned tractor 200 controls the driving of the unmanned tractor 200 according to an operation schedule from an external device, the state of the vehicle and the situation around the vehicle acquired by the vehicle sensor 201, and the positional information on the vehicle acquired by the positional information acquisition unit 202. A spraying machine 207 provided in the unmanned tractor 200 is then activated in the work area that is a part of the travel path of the unmanned tractor 200.

With the information processing system described above, the production user 10 can determine the work area where the unmanned tractor 200 is caused to spray water, fertilizer, chemicals, and the like on the crop, according to the crop environmental information acquired using the sensor group 140, and can remotely control the unmanned tractor 200 via the server 300. In this way, the user convenience in the farm work by the user producing the crop can be improved.

### Other Modifications

The aforementioned embodiment is merely illustrative, and appropriate modification can be made without departing from the scope of this disclosure. For instance, the processing and means described in this disclosure can be freely combined unless technical inconsistencies arise.

In addition, processing to be performed with one device according to the above description may be distributed to multiple devices for execution. For instance, the first acquisition unit 3031 and the generation unit 3032 may be provided in an arithmetic processing unit different from the server 300. At this time, the different arithmetic processing unit is configured to be able to suitably cooperate with the server 300. Further, processing to be performed with different devices according to the above description may be executed with one device. In a computer system, the type of hardware configuration (server configuration) used to implement each function can be flexibly changed.

This disclosure can also be implemented when a computer program having the functions described in the above embodiment is supplied to a computer, and one or more processors in the computer read and execute the program. Such a computer program may be provided to the computer via a non-transitory computer-readable storage medium that can be connected to the computer's system bus or via a network. Examples of non-transitory computer-readable memory medium include any type of disks such as magnetic disks (such as floppy (registered trademark) disks and hard disk drives (HDDs)), and optical disks (such as CD-ROMs, DVD disks, and Blu-ray disks), read only memories (ROMs), random access memories (RAMs), EPROMs, EEPROMs, magnetic cards, flash memories, optical cards, and any type of media suitable for storing electronic instructions.

What is claimed is:

1. An information processing system comprising:
a sensor;
a server device;
a user terminal; and
a work device, wherein
the sensor detects a state of a crop cultivated in each section of a farm,
the server device comprises:
a controller comprising at least one processor configured to perform acquiring state information on the state of the crop based on an output of the sensor, generating first information that is generated based on the state information and is to be transmitted to the user terminal, and transmitting a work command for causing the work device to perform predetermined work in the farm,
the user terminal notifies a user of the first information received from the server device and transmits, to the server device, second information that is input by the user notified of the first information and related to a work area that is an area where the work device is to be caused to perform the predetermined work in the farm, and
the controller of the server device transmits the work command to the work device, according to the second information transmitted from the user terminal.

2. The information processing system according to claim 1, wherein
the farm has a plurality of plots,
the sensor detects the state of the crop for each plot of the farm,
the state information includes information on the state of the crop for each plot of the farm, and
the user terminal uses, among the plurality of plots, a predetermined plot input by the user as the work area and transmits the second information on the work area to the server device.

3. The information processing system according to claim 1, wherein
the sensor is an imaging device configured to be able to capture an image of the crop, and detects the state of the crop by capturing the image of the crop,
the controller of the server device acquires image information on the crop as the state information, and generates the first information including the image information,
the user terminal uses an area that is input by the user notified of the first information received from the server device and where the work device is to be caused to harvest the crop, to be the work area, and transmits the second information on the work area to the server device, and
the controller of the server device transmits a command for causing the work device to harvest the crop, as the work command.

4. The information processing system according to claim 3, wherein the sensor is one or a plurality of mobile imaging devices provided to each of one or a plurality of flying mobile bodies.

5. The information processing system according to claim 3, wherein the sensor is one or a plurality of stationary imaging devices provided in the farm.

6. The information processing system according to claim 1, wherein the work device is one or a plurality of autonomous moving bodies that autonomously move according to a command from an external device.

7. The information processing system according to claim 3, wherein the controller of the server device generates, from the state information, proposal information on a proposal of a target area where the work device is to be caused to harvest the crop, and generates, as the first information, information further including the proposal information.

8. The information processing system according to claim 7, wherein the controller of the server device further acquires third information on weather forecast for an area including the farm, and generates the proposal information based on the third information.

9. The information processing system according to claim 7, wherein the controller of the server device generates the proposal information based on predetermined harvesting conditions determined by the user in advance.

10. An information processing device comprising a controller comprising at least one processor configured to perform:
acquiring, based on an output of a sensor capable of detecting a state of a crop cultivated in each section of a farm, state information on the state of the crop;
generating first information to transmit to a user terminal, the first information being information generated based on the state information;
transmitting the first information to the user terminal;
acquiring second information that is input to the user terminal by a user notified of the first information through the user terminal and related to a work area that is an area where a work device is to be caused to perform predetermined work in the farm; and
transmitting a work command for causing the work device to perform predetermined work in the farm, according to the second information.

11. The information processing device according to claim 10, wherein
the farm has a plurality of plots,
the sensor detects the state of the crop for each plot of the farm,
the state information includes information on the state of the crop for each plot of the farm, and
the controller uses, among the plurality of plots, a predetermined plot input by the user terminal as the work area and acquires the second information on the work area.

12. The information processing device according to claim 10, wherein
the sensor is an imaging device configured to be able to capture an image of the crop, and detects the state of the crop by capturing the image of the crop,
the controller acquires image information on the crop as the state information and generates the first information including the image information, transmits the first information to the user terminal and uses an area, input by the user to the user terminal, where the work device is to be caused to harvest the crop, to be the work area, and acquires the second information on the work area, and transmits a command for causing the work device to harvest the crop, as the work command.

13. The information processing device according to claim 12, wherein the sensor is one or a plurality of mobile imaging devices provided to each of one or a plurality of flying mobile bodies.

14. The information processing device according to claim 12, wherein the sensor is one or a plurality of stationary imaging devices provided in the farm.

15. The information processing device according to claim 10, wherein the work device is one or a plurality of autonomous moving bodies that autonomously move according to a command from an external device.

16. The information processing device according to claim 12, wherein the controller generates, from the state information, proposal information on a proposal of a target area where the work device is to be caused to harvest the crop, and generates, as the first information, information further including the proposal information.

17. The information processing device according to claim 16, wherein the controller further acquires third information on weather forecast for an area including the farm, and generates the proposal information based on the third information.

18. The information processing device according to claim 16, wherein the controller generates the proposal information based on predetermined harvesting conditions determined by the user in advance.

19. A non-transitory storage medium that stores a program that causes a computer to execute an information processing method, the computer controlling a user terminal communicating with a server device that transmits a work command for causing a work device to perform predetermined work in a farm to the work device, wherein
the information processing method comprises:
receiving, from the server device, first information generated based on state information on a state of a crop cultivated in each section of the farm;
notifying a user of the first information;
acquiring second information that is input by the user notified of the first information and related to a work area that is an area where the work device is to be caused to perform predetermined work in the farm; and
transmitting the second information to the server device.

20. A non-transitory storage medium according to claim 19, wherein
the farm includes a plurality of plots, and
the second information includes, among the plurality of plots, a predetermined plot input by the user as the work area.
